(19) United States
(12) Patent Application Publication
(10) Pub. No.: US 2015/0211081 A1
(43) Pub. Date: Jul. 30, 2015

(54) Process for Refining Impure Crystallised Sucrose

(71) Applicant: TONGAAT HULETT LIMITED, Tongaat (ZA)

(72) Inventors: David John Love, Durban North (ZA); Craig Jensen, Umdloti Beach (ZA)

(21) Appl. No.: 14/424,657

(22) PCT Filed: Aug. 27, 2013
(86) PCT No.: PCT/IB2013/058008

§ 371 Date: Feb. 27, 2015

(30) Foreign Application Priority Data
Aug. 28, 2012 (GB) 1215261.7

(51) Int. Cl. C13B 30/02

(52) U.S. Cl. CPC C13B 30/02

(57) ABSTRACT

The invention relates to a process for refining impure crystallised sucrose which process comprises the application of multiple effect falling film evaporation to concentrate without crystallisation a runoff produced on centrifugation of massecuite arising from a sucrose crystallisation process.

### FIELD OF THE INVENTION

This invention relates to the refining of impure crystallised sucrose (raw sugar) by applying multiple effect falling film evaporation to concentrate a runoff produced by centrifugation of massecuite arising from a sucrose crystallisation process.

### GLOSSARY

In this specification, the following terms have the following meanings.

Bagasse: Cane residue leaving mills after extraction of juice.

Boiling point elevation: Difference between the temperature of a boiling sugar solution and the temperature of boiling pure water, both measured at the same pressure.

Brix: Measure of dissolved solids in sugar, juice, liquor or syrup using a refractometer, otherwise referred to as refractometric dry solids. For solutions containing only sucrose and water, Brix=% sugar by mass.

Centrifugal: Centrifuge used to separate sugar crystals from mother liquor conventionally using a fine screen, allowing the mother liquor to pass through the screen whilst the crystals are retained on the screen.

Cooling crystallisation: Crystallisation by cooling of the massecuite. Massecuite exhibits direct solubility wherein the solubility threshold increases with temperature with the result that crystal growth results from simply cooling the solution. Conventionally the cooling is achieved by indirect heat transfer, i.e. heat transfer through a metal wall, to a colder cooling fluid stream. It is also possible to achieve the required cooling of the massecuite by flash cooling. This is achieved by reducing the pressure that the massecuite is exposed to, to the point where flash evaporation takes place and the massecuite cools as a result of the latent heat that is removed with the vapour so generated. The crystallisation that takes place is predominantly as a result of the resulting cooling of the massecuite, although a small proportion will be due to the increase in concentration resulting from the evaporation that takes place. In both instances this is crystallisation without heat input driven evaporation.

Crystallisation: Nucleation and/or growth of crystals.

Crystal yield for a stream: For a stream containing crystal, this is the mass of crystal expressed as a percent of the total mass of soluble solids in the stream (i.e. mass of crystal as a percent of the sum of mass of crystal and the mass of dissolved solids in the mother liquor).

Crystal yield for a process: For a process producing crystal, this is the mass of crystal produced, expressed as a percent of the total mass of soluble solids in the stream entering the process.

Evaporator effect: One of a system of evaporators operating in series as a multiple effect system (e.g., first effect, second effect). Condensates and vapours are labelled correspondingly (e.g., first condensate and vapour one: condensate and vapour from the first effect respectively).

Evaporative crystallisation: At an approximately constant temperature, achieved by holding the operating pressure constant, crystallisation occurs by increasing the solute concentration above the solubility threshold. To obtain this, the solute/solvent mass ratio is increased using evaporation that is driven by the addition of heat. The heat addition is conventionally indirect heating, i.e. heat transferred through a metal wall, using the latent heat that is released by the condensation of steam with a higher saturated vapour temperature than the temperature of the boiling solute. This is concentration with crystallisation

Falling film evaporator/evaporation: A heat exchanger where the evaporation takes place on vertical or substantially vertical surfaces, and the process fluid to be evaporated flows downwards by gravity as a continuous film. The fluid will create a film along the surfaces, progressing downwards (falling)—hence the name. Appropriately designed plates or tubes may be used as the surface for the fluid to flow over, but it will be appreciated that other embodiments of falling film evaporators are included in the ambit of this description. Falling film evaporators are very susceptible to solid fouling, for example, through crystallisation and are therefore inappropriate for use in evaporative crystallisation.

Liquor: A sugar syrup, a term generally used in sugar refining.

Magma: The mixture of crystals and liquor created my mixing these two products

Massecuite: The mixture of crystals and mother liquor resulting from the crystallisation process.

Melting: Another term for dissolving of sugar crystals.

Molasses: The mother liquor separated from the crystals by centrifuging.

Mother liquor: Liquid phase in the massecuite during crystallisation; refers to syrup or liquor in which the crystals are growing.

Multiple effect evaporation: Effective use of the heat from steam to evaporate water wherein water is boiled in a sequence of vessels, each held at a lower pressure than the last, Because the boiling temperature of water decreases as pressure decreases, the vapour boiled off in one vessel can be used to heat the next, and only the first vessel (at the highest pressure) requires an external source of heat.

Pan or vacuum pan: Vacuum evaporative crystalliser used in the sugar industry to crystallise sugar from liquor, syrup or molasses.

Polarization (or pal): The apparent sucrose content expressed as a mass percent measured by the optical rotation of polarized light passing through a sugar solution. This is accurate only for pure sucrose solutions.

Raw sugar: Brown sugar produced in a raw sugar mill generally destined for further processing to white sugar in a refinery.

Recovery house: A section of a sugar refinery that produces crystalline sugar that is not of sufficiently high enough purity to be classified as refined sugar, and in consequence is conventionally recycled as input to the refinery where it is treated as if it were raw sugar.

Refinery: A processing plant designed to refine raw sugar to produce refined sugar

Refined sugar: A very high purity sugar (sucrose) that is conventionally above 99.9% with specifications on the maximum levels of various impurity components, most importantly colour (e.g. less than 50 ICUMSA Colour Units)

Refining: Purification of sugar through chemical and physical methods, generally including some or all of dissolution, clarification, filtration, decolourisation and recrystallisation.

Runoff: General term for syrups or molasses produced on centrifuging a massecuite.

Saturation: A sugar solution at saturation will not dissolve any more crystals at the temperature of the solution.

Seeding: (a) Introducing crystal fragments to induce nucleation, as a means of initiating the crystallisation process; (b) introduction of fine crystals in the form of a slurry (similar to full seeding) to start crystallisation.

Seed: Suspension of fine crystals in saturated solution of alcohol, or the initial grain resulting from seeding in a vacuum pan.

Sucrose: Pure chemical compound C₁₂H₂₂O₁₁ known as white sugar, generally measured by polarization in pure solution or by Gas Chromatography (GC) or High Performance Liquid Chromatography (HPLC) in impure solution. The chemical term is P-D-Fructofuranosyl α-D-glucopyranoside.

Sugar: Term for the disaccharide sucrose and products of the sugar industry, essentially composed of sucrose.

Supersaturation: The degree to which the sucrose content in solution is greater than the sucrose content in a saturated solution.

Syrup: The concentrated juice or sugar solution from the evaporators.

Vapour: Generally used to describe steam that is produced by the evaporation of a process stream, rather than steam produced by a boiler that evaporates high purity water. Vapour streams are often at pressures below atmospheric pressure.

Vapour bleeding: The process of withdrawing vapour from one or more of the vapour streams within a multiple effect evaporator station. By using this vapour in place of steam of the same type as that used to feed the multiple effect evaporator station, there is a saving of steam.

Vapour compression: A technique for improving energy efficiency by increasing the pressure and thereby the temperature of a vapour stream. This can be done using a venturi nozzle driven by an injection of high pressure steam (thermocompression) or by a mechanical compressor (vapour recompression).

### BACKGROUND OF THE INVENTION

Sucrose is a disaccharide compound used throughout the world in food-processing applications as a sweetener. Crystalline sucrose is primarily produced from the sugarcane plant which is cultivated in the tropical and semitropical regions of the earth. In this specification, the term sugar is considered to mean sucrose.

Throughout the world today, refined cane sugar from sugarcane has been accomplished in two steps: (a) the raw sugar process; and (b) the refinery process.

In the raw sugar process, sugar mills, located in or near the cane fields, convert the harvested sugarcane plant into a commodity of international commerce known as raw sugar (impure crystallised sucrose). The raw sugar is transported to sugar refineries, located in population centres throughout the world, where it is converted into its various refined end products. In contrast to the sugar mill, almost the entire output of the sugar refinery is intended, in one form or another, for human consumption.

In the production of raw sugar in the sugar mill, the sugarcane stalks are chopped into small pieces. Then, cane juice is extracted from the sugarcane, leaving behind a fibrous material called bagasse. The extracted juice is then clarified to yield a lighter-coloured raw sugar solution (juice). The clarified juice is then processed through a series of evaporators to eliminate water, which is approximately 85% of the cane juice, resulting in a concentrated sugar solution called syrup. The syrup is then put through a crystallization process, which generates sugar crystals and further separates impurities. Finally, centrifugation separates raw sugar from the syrup, now termed molasses. The molasses is usually processed more than once so that as much of the sugar as possible can be recovered from the syrup.

In the sugar refinery, the raw impure sugar crystals from the sugar mill are cleaned and then melted (dissolved in water). Then, the sugar solution is purified and (optionally) decolourised (including by way of carbonatation, phosphotation, ion exchange, carbon and combinations of these). The sugar solution is then passed through evaporators to remove some of the water and the remaining product is then passed to a vacuum pan for further evaporation and crystallization. Typically refinery crystallisation utilises vacuum evaporative crystallisation equipment. The crystallisations are carried out in batch evaporative crystallisers or continuous evaporative crystallisers. Evaporative crystallisers are commonly referred to the sugar industry as “pans”. The end product is then passed through centrifuges to separate the pure sucrose crystals from the mother liquor to yield refined sucrose crystals and runoff. Since the majority of the impurities are contained within the mother liquor it is important to remove even the smallest quantity of mother liquor adhering to the crystals. To achieve this it is conventional to wash the crystals with hot water and finally purge them with steam whilst the crystals are still retained within the centrifugal basket. Careful attention to both the method and quantity of water addition is necessary to maximise the purging of the mother liquor whilst minimising any crystal dissolution.

In the sugar mill (in which sugar is recovered from cane juice) the purification process is also via re-crystallisation, both by evaporative crystallisation and by cooling. Where cooling crystallisation is used the equipment is referred to simply as a “crystailiser”.

This basic process, raw sugar manufacturing followed by raw sugar refining, is the process commonly used throughout the world today to produce high-quality white refined cane sugar (sucrose) with a polarization (or, optically measured purity) of from about 99.90% to 99.99%. It is a two-step process which is employed even in locations where there is a sugar refinery near, or even within, a sugar mill. Even entities outside the sugar industry have arranged their business affairs to accommodate this state of the technology. Raw (impure) sugar is traded worldwide as a commodity on the New York and London stock exchanges.

Thus sugar mills produce crude sugar products, their main product being raw (impure) sugar whilst high-quality refined sugars demanded in major population centres come from the sugar refinery which is a technologically sophisticated operation that employs expensive equipment and numerous chemicals and consumes large amounts of energy in order to produce the refined sugar product (sucrose crystals).

Regardless of which upfront process is used to provide a decolourised feed to the refining process, the known processes in sugar refining have the following drawbacks arising from the crystallisation purification step.
1. The art relies on evaporative crystallisation. To optimise the crystallisation process (i.e. grow crystals of a suitable size but minimise both the formation and the inclusion of impurities) requires careful temperature and supersaturation control. When using evaporative crystallization the use of vacuum is important to control temperature, and evaporation is required to remove water and maintain the supersaturation. The crystallisation and evaporation process are carried out in a single unit, Designing equipment to achieve energy efficient evaporation and the requirements for optimum crystallisation conditions is difficult because the crystallisation and evaporation processes are not carried out independently.
2. As a result of 1), traditional refining is an energy intensive process. The standard energy optimisation techniques used to optimise evaporation e.g. multiple effect evaporation, vapour compression and vapour bleeding, have very limited application to vacuum crystallisers (pans).

The invention now makes it possible to produce high quality refined sugar at greatly reduced energy consumption. Thus, the invention facilitates the conservation of energy and material resources and minimizes environmental pollution. In particular there is (without limitation):
greatly reduced need for fuel (normally in the form of coal or fuel oil)
greatly reduced need for major pieces of capital equipment (e.g. boilers and cooling towers),
reduced process demand for water (due to improved recycle within the plant), and
reduced electrical demand (associated with pumping of water for condensing vapours from pans).

### SUMMARY OF THE INVENTION

According to a first aspect to the present invention there is provided a process for refining impure crystallised sucrose, the process comprising the application of multiple effect falling film evaporation to concentrate without crystallisation a runoff produced on centrifugation of massecuite arising from a sucrose crystallisation process.

As such, it will be appreciated that concentration according to the present invention takes place by evaporation from a solely liquid phase stream, in the absence of any crystalline sucrose.

The sucrose crystallisation process may be a cooling crystallisation process, where the crystallisation takes place without any heat input driven evaporation.

The impure crystallised sucrose is derived from sugarcane and in one embodiment is obtained from a sugar mill.

In one embodiment the runoff has a Brix value of from approximately 66 to approximately 72 before the application of multiple effect falling film evaporation.

The runoff (syrup) may have a Brix value of from approximately 80 to approximately 83 after the application of multiple effect falling film evaporation.

In one embodiment of the present invention the multiple effect falling film evaporation is integrated into a single operation. The multiple effect evaporation may be a two effect, three effect, four effect or five effect evaporation.

The first effect of the multiple effect evaporation may be achieved by supplying steam to a first evaporator at a pressure of approximately 160 to approximately 220 kPa (kilopascal) absolute with corresponding vapour saturation temperatures of approximately 113.3 to approximately 123.3 degrees Centigrade.

The last effect of the multiple effect evaporators may run at a pressure of between approximately 10 and approximately 30 kPa absolute corresponding to saturated vapour temperatures of between approximately 45.8 and approximately 69.1 degrees Centigrade.

In one embodiment, the process includes bleeding steam for use outside the evaporator system. The process may also include bleeding or otherwise using clean water condensed from the steam used in the multiple effect evaporation.

The sugar crystals may be washed during or following centrifugation. In one embodiment the sugar crystals are washed using a liquor, for example a hot liquor, a secondary liquor and/or a fine liquor.

The process may include seeding the liquor or syrup prior to crystallisation. This comprises the addition of the requisite number of small crystals so that these seed crystals grow throughout the crystallisation process to provide product crystals of the required size (normally between 0.4 and 0.7 mm). The crystallisation process is carefully controlled to ensure that only the added seed crystals grow whilst no new seed crystals are allowed to arise by nucleation and then continue to grow.

As such, the process according to the invention may include the following steps:
a) Concentrating (without crystallisation) a fine liquor feed stream comprising raw sugar in aqueous solution by falling film evaporation to derive a hot, concentrated syrup,
b) Seeding the syrup with the requisite number of small crystals to create a massecuite,
c) Cooling the syrup to grow the sugar crystals within the massecuite,
d) Recovering by centrifugation the sugar crystals from the massecuite to leave a first runoff,
e) Concentrating (without crystallisation) the first runoff by falling film evaporation to derive a concentrated syrup,
f) Seeding the syrup with the requisite number of small crystals to create a massecuite,
g) Cooling the concentrated syrup grow the sugar crystals within the massecuite,
h) Recovering the sugar crystals to leave a second runoff,
i) Repeating steps e) to h) mutatis mutandis at least twice more by way of multiple effect evaporation, and
j) Directing the final runoff to a recovery house for economic recovery of sugars remaining within this stream.

The sugar crystals recovered may be washed with liquor, for example, the fine liquor of step a).

The cooling to derive sugar crystals is effected in a cooling crystalliser. The temperature difference in the cooling crystalliser between the syrup feed and the massecuite derived from the crystalliser may be from approximately 95 degrees Centigrade to approximately 25 degrees Centigrade.

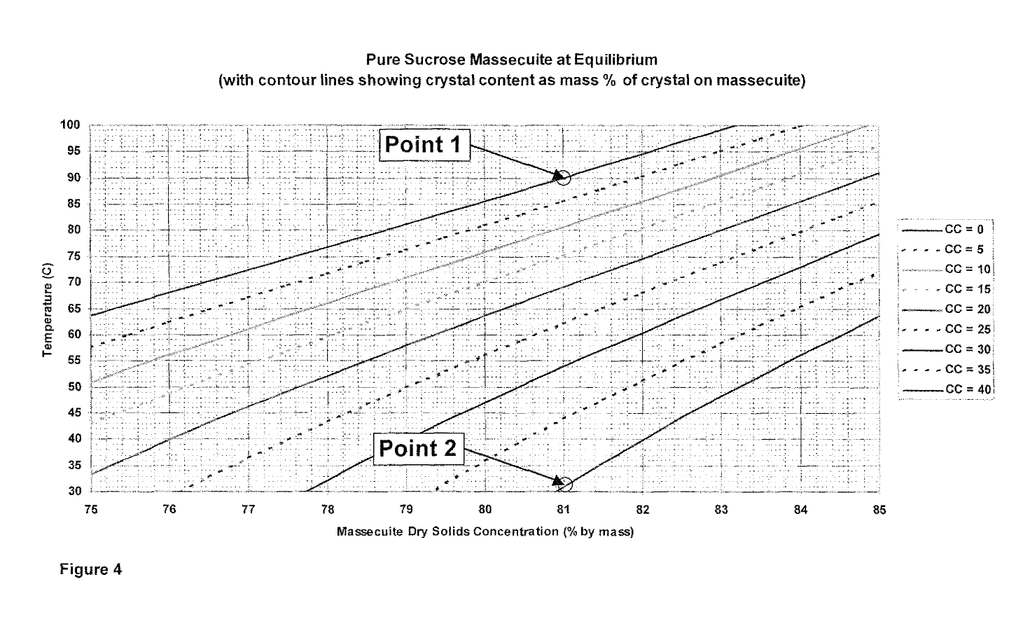

Sucrose will crystallise from a hot concentrated solution (exhibiting no crystallisation) as the hot concentrated solution is cooled. This is illustrated in FIG. 4. As an example, a pure sucrose solution with a concentration of 81% dry solids and a temperature of 90 degrees Centigrade will be at equilibrium (a saturated solution)—point 1 on FIG. 4. As the temperature of this solution is decreased crystallisation will take place and, if sufficient time is allowed for the mother liquor to reach equilibrium with the crystallised sucrose, the extent of crystallisation is shown by the contours on the graph. For example at a temperature of 31 degrees Centigrade equilibrium will be achieved when the quantity of sucrose crystallised rises to 40% by mass of the massecuite—point 2 on FIG. 4.

The temperature of the fine liquor/syrups derived from the falling film evaporation steps may be from approximately 85 to approximately 100 degrees Centigrade.

Steps a) and e) may be effected in a single operation.

According to second aspect of the present invention there is provided a refined crystallised sucrose produced by a process as hereinbefore described.

### DETAILED DESCRIPTION

The process according to the invention separates the evaporation and crystallisation steps so that each may be separately, and independently, optimised. This separation (decoupling) is achieved by:
1. Using cooling crystallisation instead of evaporative crystallisation for the crystallisation step
   i. To ensure that impurity transfer is minimised due to slower and more uniform crystallisation conditions, and
   ii. That the Brix of the mother liquor is lower than that of the mother liquor resulting from evaporative crystallisation.
2. Evaporation is carried out as a separate operation using optimised technology meaning that
   i. The several mother liquor streams are concentrated only in liquid phase (without crystallisation) using multiple effect evaporation, and
   ii. The several multiple effect evaporation streams are integrated into a configuration so that energy consumption is minimised.
   iii. Falling film evaporation technology is used to allow four or more effects of evaporation using the limited overall temperature driving force between a supply steam pressure of approximately 160 to approximately 220 kPa absolute and a final effect pressure of between approximately 10 and approximately 30 kPa absolute.
   iv. The flow of liquors through the evaporators is so configured so that at all times the concentrating sugar solutions are always below saturation (as determined from their temperature and concentration) so that no crystallisation occurs the final concentrated solutions exiting from the evaporator being appropriately both hot and concentrated to match the requirements for the start of the cooling crystallisation process.

The process according to the invention may use a hot (decolourised) liquor for washing the sugar crystal free of the mother liquor in the centrifugation step. This has the effect of improving steam economy in the following way:
a. It reduces the water required for washing the crystals free of the impure mother liquor. Any water added in the process has to be subsequently removed from the runoff by evaporation with the corresponding use of steam.
b. It heats the sugar crystals so as to facilitate subsequent drying of those crystals. Sugar manufacture by cooling crystallisation processes suffer with drying cold sugar crystals because it is difficult, during air drying of crystals, to supply the energy necessary to evaporate the water if this has to come from heated air rather than heated crystals.
c. Small crystals i.e. those that are not retained in the centrifugal basket and exit with the molasses (runoff) need to be dissolved before the next stage of crystallisation commences. In traditional processing the small crystals are dissolved using water either during the water washing of the crystals within the basket or subsequently by diluting and heating the mother liquor run-off. The use of hot liquor in this process (if it is at saturation) will not dissolve those small crystals but in the proposed process these crystals will be dissolved by temperature rise as the liquor passes through the multiple effect evaporator. Again this saves energy in comparison with the traditional process where the water added would need to be removed by evaporation.
d. The use of low colour liquor to displace the remaining, high colour, mother liquor adhering to the crystals within the centrifuge can achieve removal without the dissolution of product crystals that occurs with conventional water washing. This avoidance of dissolution saves energy as the need to re-crystallise this dissolved sugar is eliminated.

The final runoff mother liquor is sent to a recovery house:
a. Which can be a standard operation as is known in the art,
b. May use the same technology as hereinbefore described to recover crystal sugar that is re-melted for recovery as a commercial grade white sugar, and/or
c. May be used for the manufacture of liquid sugar or other products.

According to the present invention significant energy saving in sugar refining can be achieved (as compared with values taught in the art). Measuring the quantity of steam used, expressed relative the quantity of raw (impure) sugar melted reveals the following comparison.

TABLE 1
Sugar Refinery Benchmarking

| | Steam | Process | Electrical | Total Power |
|---|---|---|---|---|
| Refinery | % Raw | Steam | Power | Consumption |
| Al Khaleej Sugar | 82% | 2185 MJ/t | 235 MJ/t | 2450 MJ/t |
| (1999 Data - | | | | |
| Monthly | | | | |
| Averaqe) | | | | |
| Al Khaleej Sugar | 62% | 1650 MJ/t | 210 MJ/t | 1925 MJ/t |
| (2000 Data - Best | | | | |
| Monthly | | | | |
| Averaqe) | | | | |
| Savannah Sugar | 123%/ | — | 188 MJ/t | 3838 MJ/t |
| Refinery | 143% | | | |
| (1959 Average | | | | |
| Data) | | | | |
| Manitoba Sugar | — | — | — | 5815 MJ/t |
| Company | | | | |
| (Back-end beet | | | | |
| refinery) | | | | |
| Thames Refinery | 98% | 2556 MJ/t | 238 MJ/t | 3468 MJ/t |
| (1978 Weekly | | | | |
| Data) | | | | |
| Westcane Sugar | 94% | — | — | 3123 MJ/t |
| Limited | | | | |
| (1979 Annual | | | | |
| Data) | | | | |
| Thames Refinery | 92% | — | — | — |
| (1982 Annual | | | | |
| Data) | | | | |
| Huletts | 108% | 2331 MJ/t | 243 MJ/t | 2574 MJ/t |
| Refinery | | | | |
| Design Values | | | | |
| Refining Process | 45% | 1200 MJ/t | 150 MJ/t | 1350 MJ/t |
| according to | | | | |
| present invention | | | | |
| (est.) | | | | |

### SPECIFIC DESCRIPTION

The invention will now be described with reference to the following non-limiting figures in which:

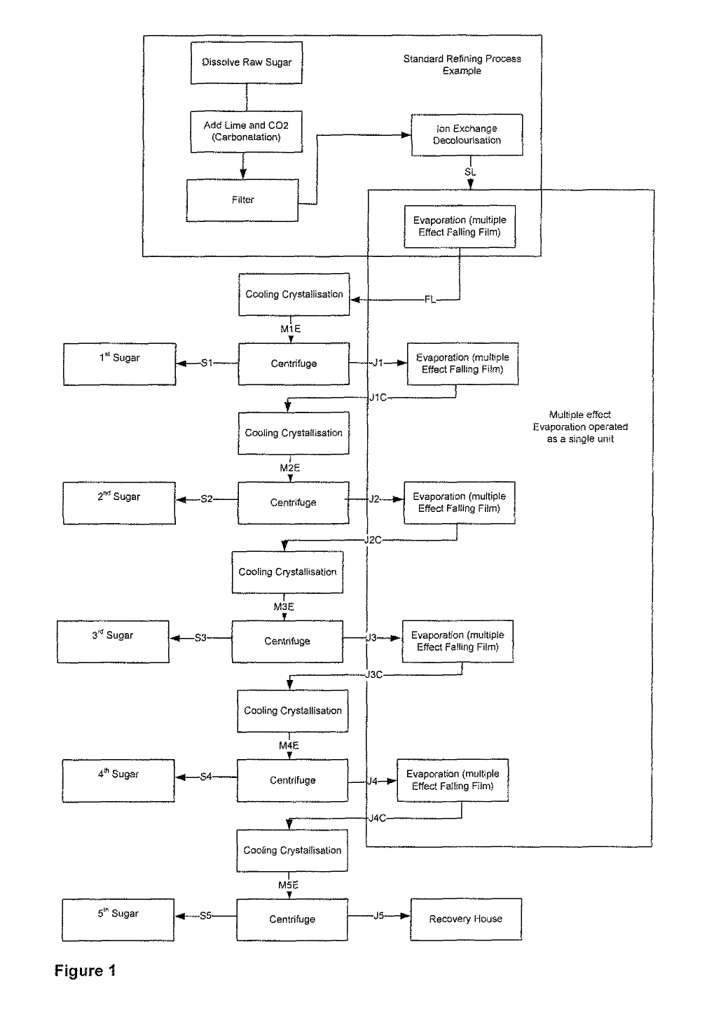

FIG. 1 is schematic representation of the refining process according to the present invention,

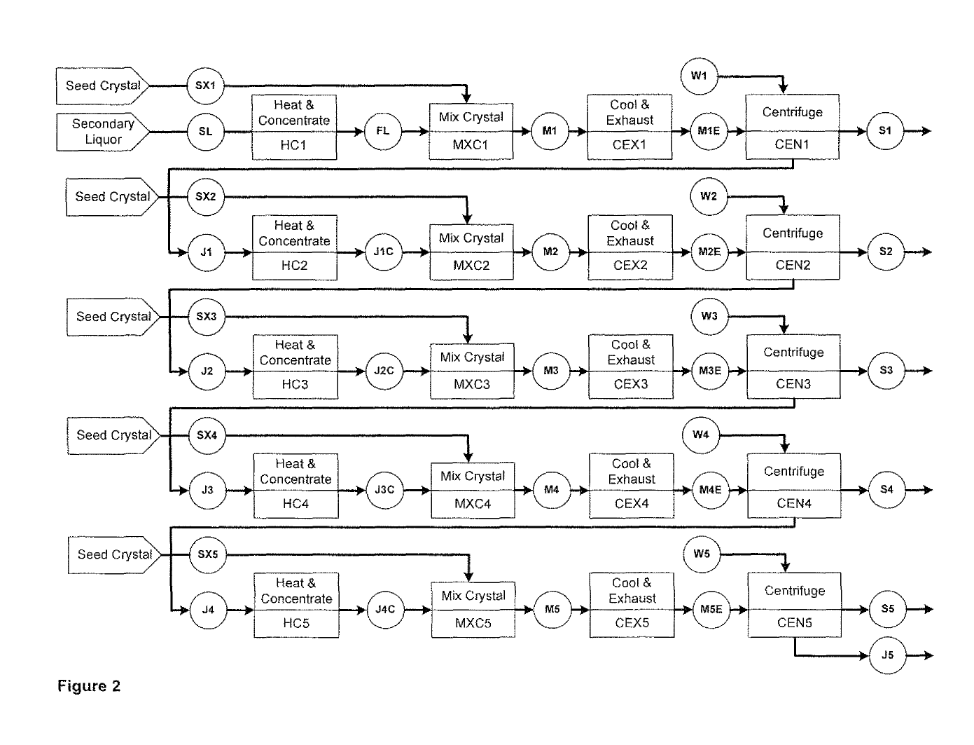

FIG. 2 is an example of a mass balance flow sheet of the evaporation/crystallisation process according to the present invention; and

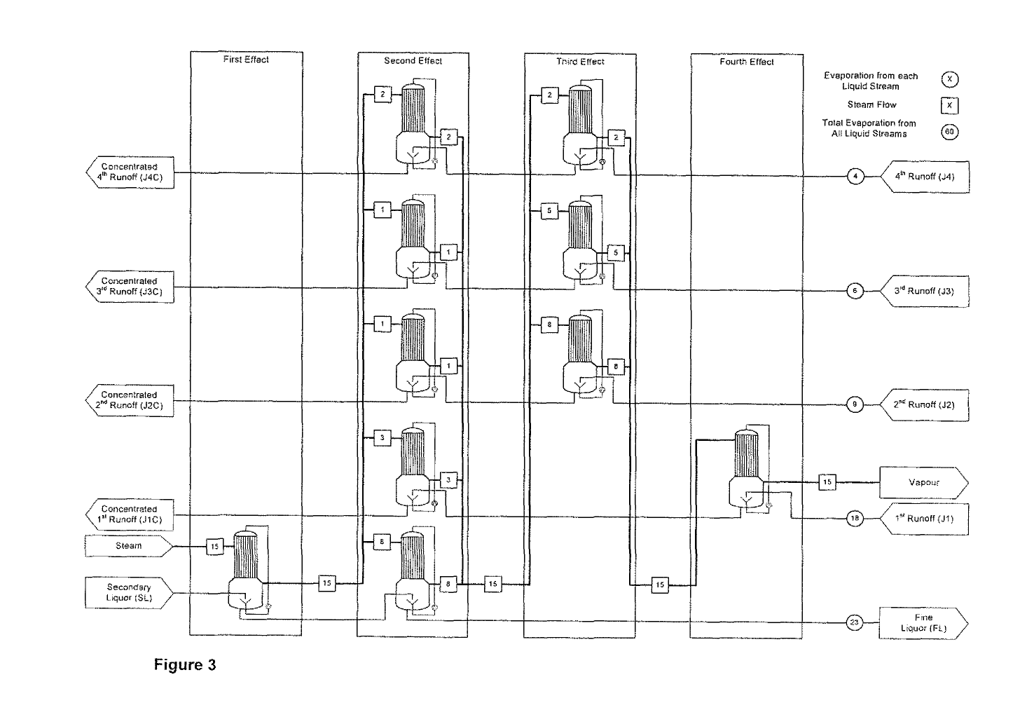

FIG. 3 is a schematic illustration of a multiple effect evaporation arrangement of multiple streams as a single integrated unit.

FIG. 4 is a graph showing contours of crystal content for a pure sucrose solution in equilibrium with sucrose crystals for specified temperatures and solids concentrations of the massecuite (the slurry of crystals and mother liquor).

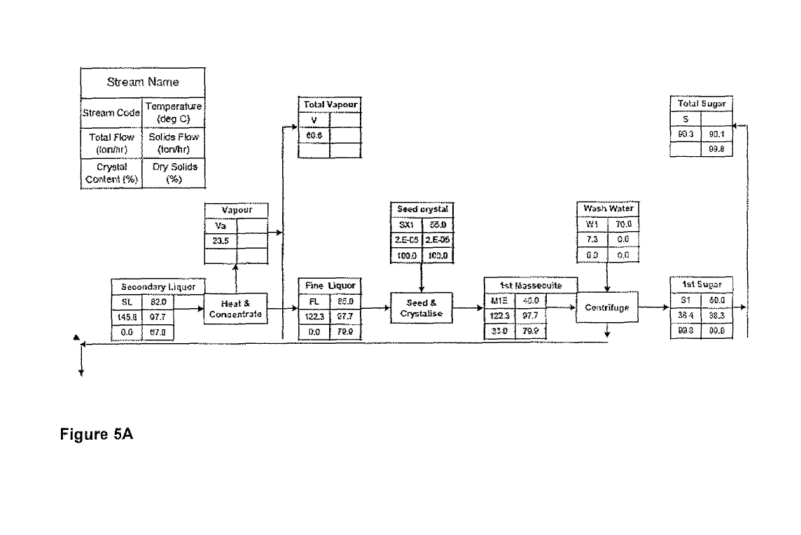

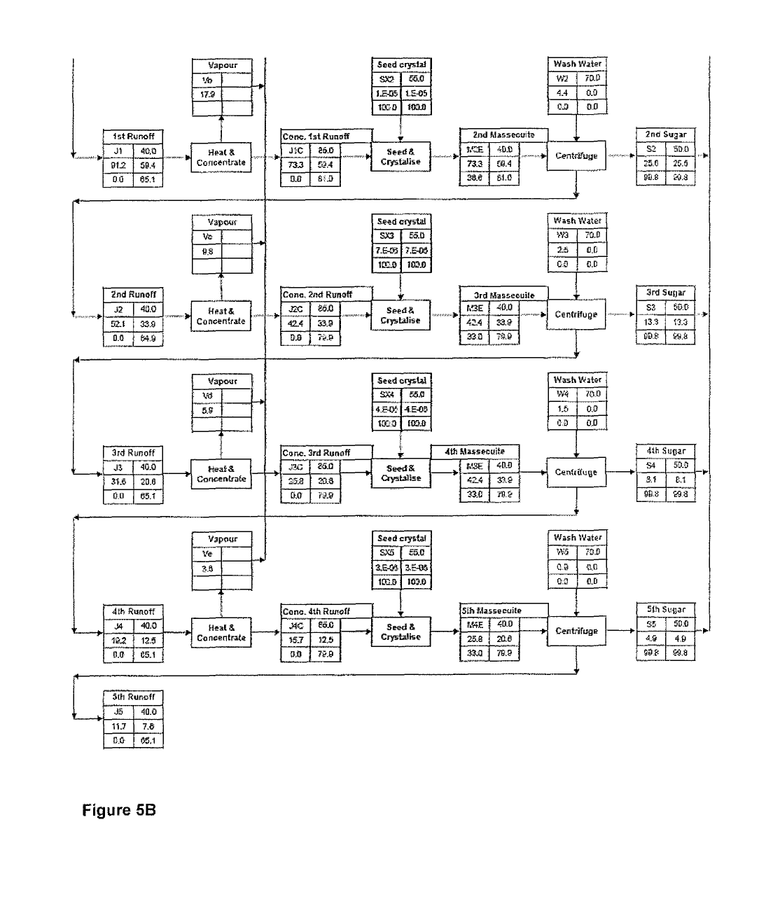

FIGS. 5A and B together constitute a mass balance for a refining process according to the present invention that uses five successive cooling crystallisation stages.

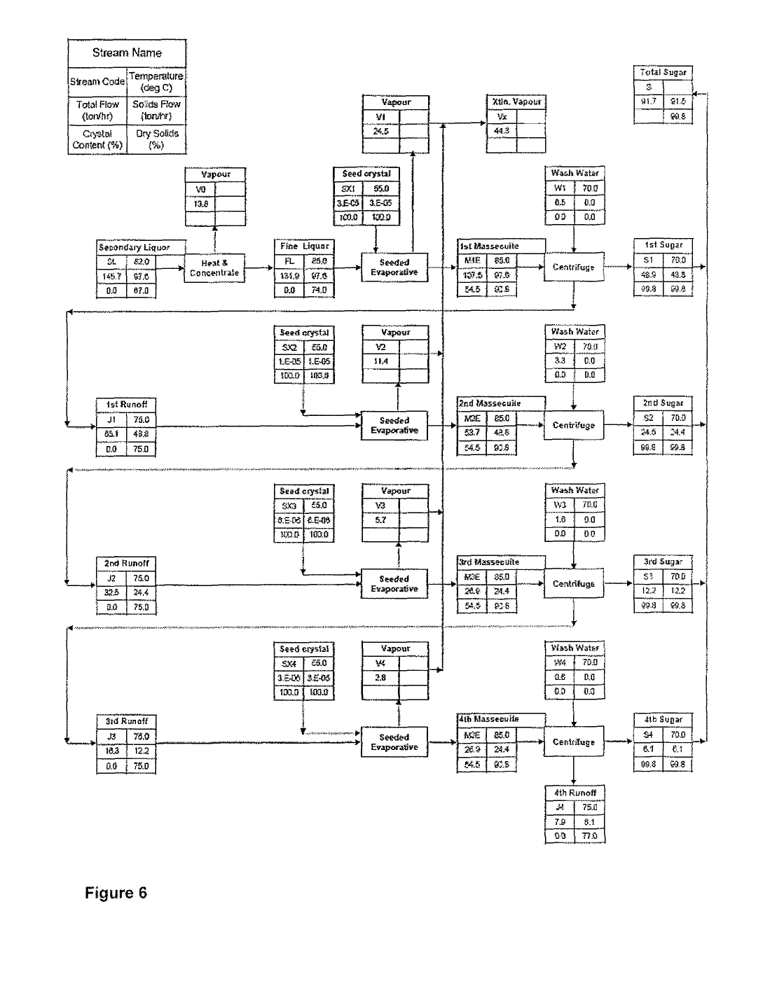

FIG. 6 is a mass balance for a conventional refining process that uses four successive evaporative crystallisation stages.

In FIG. 1 raw sugar from a sugar mill is dissolved, purified and decolourised (for example, by way of carbonatation, phosphotation, ion exchange, carbon and/or combinations of these) to derive a secondary liquor (SL). The secondary liquor (SL) is concentrated (without crystallisation) in a falling film evaporator to yield a fine liquor (FL). The fine liquor (FL) is subject to cooling crystallisation to yield a first massecuite (M1E) which is centrifuged to yield a first sugar (S1) and a first runoff (J1). The first (cool) runoff (J1) is concentrated (without crystallisation) in a falling film evaporator to yield a first syrup (J1C).

The first syrup (J1C) is subject to cooling crystallisation to yield a second massecuite (M2E) which is centrifuged to yield a second sugar (S2) and a second runoff (J2). The second (cool) runoff (J2) is concentrated (without crystallisation) in a falling film evaporator to yield a second syrup (J2C).

The second syrup (J2C) is subject to cooling crystallisation to yield a third massecuite (M3E) which is centrifuged to yield a third sugar (S3) and a third runoff (J3). The third (cool) runoff (J3) is concentrated (without crystallisation) in a falling film evaporator to yield a third syrup (J3C).

The third syrup (J3C) is subject to cooling crystallisation to yield a fourth massecuite (M4E) which is centrifuged to yield a fourth sugar (S4) and a fourth runoff (J4). The fourth (cool) runoff (J4) is concentrated (without crystallisation) in a falling film evaporator to yield a fourth syrup (J4C).

The fourth syrup (J4C) is subject to cooling crystallisation to yield a fifth massecuite (M5E) which is centrifuged to yield a fifth sugar (S5) and a fifth runoff (J5). The fifth runoff (J5) is directed to a recovery house.

The falling film evaporators are multiple effect operated as a single unit to concentrate the fine liquor and the first four runoffs (without crystallisation).

It will be appreciated that (as a first approximation) in a multiple effect evaporator of 4 effects one kilogram (kg) of steam will evaporate 4 kg of water. In addition, if vapour is withdrawn (bled) from for example, the second effect of the evaporator and this vapour is used outside of the evaporator system in place of steam, the steam saving will be 2/4 times the quantity of steam used in this duty. These two important energy saving concepts are well known within the sugar industry as Rilleaux's Principles.

In FIG. 2 the secondary liquor (SL) is heated and concentrated (without crystallisation) in a multiple effect falling film evaporator to derive a fine liquor (FL). The FL is seeded with seed crystals SX1 which mixture (M1) is then subject to cooling crystallisation to derive a first massecuite (M1E) which is then centrifuged and washed with a wash liquor (W1) to yield a first sugar (S1) and a first runoff (J1).

J1 is then heated and concentrated (without crystallisation) in a multiple effect falling film evaporator to derive a concentrated 1^{st} runoff (J1C). The J1C is seeded with seed crystals SX2 which mixture (M2) is then subject to cooling crystallisation to derive a first massecuite (M2E) which is then centrifuged and washed with a wash liquor (W2) to yield a second sugar (S2) and a second runoff (J2).

This process is repeated three more times to finally yield a fifth sugar (S5) and fifth runoff (J5) which is directed to a recovery house (not shown).

The diagram in FIG. 5 shows representative values for a refining process according to the present invention that uses five successive cooling crystallisation stages. The values presented are based on the following assumptions:
a) Impurities are neglected, all the solids (dissolved or crystalline) are assumed to be pure sucrose. This is done to illustrate the major principles of the proposed process without the distraction of the relatively minor effects that the impurities will have on the mass balance (since impurities in the feed to refinery will be of the order on only half a percent by mass).
b) The input flow of secondary liquor is chosen to represent the feed to a conventional refining process that produces approximately 90 tons per hour (ton/hr) of refined sugar in four stages of evaporative crystallisation.
c) Seeding of the crystallisation process is done with 4 micron seed crystals of sufficient quantity to achieve a product crystal size of approximately 500 micron.
d) Each cooling crystallisation stage starts with the feed concentrated to saturation at 85 degrees Centigrade but without crystallisation. This is cooled to a final temperature of 40 degrees Centigrade to promote crystallisation, before centrifugation to recover the product crystal.
e) The crystals are washed in the centrifugals with water only (the benefits of liquor washing are not included in this simulation) with a water quantity set at 5% on massecuite by mass.
f) It is assumed that 5% of the crystal sugar at the end of the cooling crystallisation step is dissolved by the wash water in the centrifugals.
g) The balance is a simple mass balance (not a full heat and mass balance)—in this example temperatures of streams have been selected using engineering judgement.

The diagram in FIG. 6 shows representative values for a conventional refining process that uses four successive evaporative crystallisation stages. The values presented are based on the following assumptions:
a) Impurities are neglected, all the solids (dissolved or crystalline) are assumed to be pure sucrose. This is done to illustrate the major principles of the conventional refining process without the distraction of the relatively minor effects that the impurities will have on the mass balance (since impurities in the feed to refinery will be of the order on only half a percent by mass).
b) The input flow of secondary liquor is chosen to represent the feed to a conventional refining process that produces approximately 90 ton/hr of refined sugar in four stages of evaporative crystallisation.
c) The secondary liquor is concentrated to a fine liquor of 74% dry solids for feed to the first stage of crystallisation. This is a practical maximum value because higher values have the risk of unwanted crystallisation in storage tanks and the risk of problems with control of crystallisation conditions within the evaporative crystallisation process.
d) Seeding of the crystallisation process is done with 4 micron seed crystals of sufficient quantity to achieve a product crystal size of 500 micron.
e) Each evaporative crystallisation stage takes place at a temperature of 85 degrees Centigrade. The extent of crystallisation is determined by assuming that at the end of each crystallisation stage the mother liquor is at saturation and the quantity of crystal present is 60% of the total solids present in the massecuite (i.e. a crystal yield of 60%).
f) The crystals are washed in the centrifugals with water only (the benefits of liquor washing are not included in this simulation) with a water quantity set to achieve a run-off concentration of 75% dry solids. This then also accounts for the water added after the centrifugals—necessary to ensure dissolution of any small crystals that have passed through the centrifugal screen.
g) The extent of dissolution of crystals by the wash water in the centrifugals is calculated based on the assumption that the overall yield for each crystallisation stage is 50%—a value approximating normal industrial performance.
h) The balance is a simple mass balance (not a full heat and mass balance)—in this example temperatures of streams have been selected using engineering judgement.

The energy saving benefits of the proposed process for producing refined sugar (using cooling crystallisation and multiple effect evaporation) can be seen by a comparison of the mass balance data in FIG. 5 (proposed process) with the data in FIG. 6 (conventional process).

The data in FIG. 6 show that a conventional refining process will requires evaporation of 58.1 tons/hr to produce 91.7 tons/hr of sugar. This evaporation is made up from 13.8 tons/hr of evaporation from the secondary liquor and 44.3 tons/hr of evaporation from evaporative crystallisation. Using the standard approximation that a single ton of evaporation requires a single ton of steam, the steam demand of this process is equivalent to 0.634 tons steam per ton sugar produced (58.1/91.7).

The steam efficiency of this conventional process can be improved by using multiple effect evaporation to concentrate the secondary liquor. If this is done in four effects, the steam requirement for concentrating the secondary liquor reduces to 3.5 tons/hr (13.8/4) and the total steam demand for the process then reduces to 47.8 tons/hr (44.3+3.5). Under these circumstances the steam efficiency of the process improves to 0.521 tons steam per ton sugar produced (47.8/91.7).

The data in FIG. 5 show that the proposed refining process will require evaporation of 60.6 tons/hr to produce 90.3 tons/hr of sugar. Using the standard approximation that a single ton of evaporation requires a single ton of steam, the steam demand of this process (if all evaporation is done in single effect) is equivalent to 0.671 tons steam per ton sugar produced (60.6/90.3). The energy efficiency of the proposed process is achieved by undertaking all of this evaporation using multiple effect evaporation. If this is done in four effects, the steam requirement reduces to 15.2 tons/hr (60.6/4). This results in a steam efficiency of the process of 0.168 tons steam per ton sugar produced (15.2/90.3).

On this basis, the specific steam demand of the proposed refining process with quadruple effect evaporation is then only 26.5% of the demand for a conventional refining process that uses single effect liquor evaporation (0.168/0.634*100). Alternatively, the specific steam demand of the proposed refining process is only 32.2% of the demand for a conventional refining process that uses quadruple effect liquor evaporation (0.168/0.521*100).

Since there are diminishing returns for applying multiple effect evaporation to secondary liquor evaporation in the conventional refining process, an equitable comparison of the energy efficiency of the proposed refining process with that for a conventional refining process will likely lie between the two figures quoted above (i.e. between 26.5 and 32.2%).

FIG. 3 illustrates a multiple effect evaporation arrangement of all streams as a single integrated unit, according to the invention. Steam input of 15 units over four effects will yield 60 units total evaporation from all liquid streams. Vapour bleeding is not shown in this embodiment.

In FIG. 3 steam flow in a given effect will always total the input steam flow to that effect. The example mass balance for the proposed cooling crystallisation process shown in FIG. 5 has a total evaporation requirement of 60.6 tons/hr. As an approximation, to facilitate demonstration of how multiple effect evaporation can be applied to achieve substantial energy savings, the evaporation requirements can be summarised as:

| | |
|---|---|
| Concentration of secondary liquor | 23 tons/hr |
| Concentration of 1st runoff | 18 tons/hr |
| Concentration of 2nd runoff | 9 tons/hr |
| Concentration of 3rd runoff | 6 tons/hr |
| Concentration of 4th runoff | 4 tons/hr |
| Total evaporation requirements | 60 tons/hr |

Based on Rilleaux's first principle (previously described) that one ton of vapour will produce one ton of evaporation, a quadruple (four) effect evaporator can be expected to achieve the total 60 ton/hr evaporation requirement with a supply of only 15 ton/hr of steam (60/4). Whilst quadruple effect evaporators can be applied to each of the streams requiring evaporation to achieve this saving, it will be more cost effective to integrate all the evaporation requirements into a single multiple effect evaporator station. An example of how this can be achieved is shown in FIG. 3.

As illustrated in FIG. 4, a cooling crystallisation stage applied to a pure sucrose stream starting at a temperature of 90 degrees Centigrade and a concentration of 81% dry solids by mass will be at equilibrium after cooling to 31 degrees Centigrade when the crystal content is 40% by mass of the massecuite. The crystal thus formed represents 40/81*100=49.4% of the sucrose in the initial stream. By balance 100−49.4=50.6% of the sucrose remains in the mother liquor. As a first approximation the, each stage of crystallisation can be assumed to remove 50% of the sucrose in the entering stream, leaving the balance of 50% to pass on to the next stage of crystallisation. Using this approximation for a five stage crystallisation process fed with 32 mass units of sucrose, the sugar produced by each stage of crystallisation will be:

| | | |
|---|---|---|
| Sugar from first stage of crystallisation | 16 | mass units |
| Sugar from second stage of crystallisation | 8 | mass units |
| Sugar from third stage of crystallisation | 4 | mass units |
| Sugar from fourth stage of crystallisation | 2 | mass units |
| Sugar from fifth stage of crystallisation | 1 | mass unit |
| Sucrose rmng. in mother liquor | 1 | mass unit |
| 5th stage of crystallisation | | |

1. A process for refining impure crystallised sucrose, the process comprising the application of multiple effect falling film evaporation to concentrate without crystallisation a runoff produced on centrifugation of massecuite arising from a sucrose crystallisation process.

2. A process according to claim 1 wherein the sucrose crystallisation process is a cooling crystallisation process.

3. A process according to claim 1 wherein the impure crystallised sucrose is derived from sugarcane.

4. A process according to claim 1 wherein the runoff has a Brix value of from 66 to 72 before the application of multiple effect falling film evaporation.

5. A process according to claim 1 wherein the runoff (syrup) has a Brix value of from 80 to 83 after the application of multiple effect falling film evaporation.

6. A process according to claim 1 wherein the multiple effect falling film evaporation is integrated into a single operation.

7. A process according to claim 1 wherein the multiple effect evaporation is a two effect, three effect, four effect or five effect evaporation.

8. A process according to claim 1 wherein a first effect of the multiple effect evaporation is achieved by supplying steam to a first evaporator at a pressure of between approximately 160 to 220 kPA absolute with corresponding vapour saturation temperatures of 113.3 to 123.3 degrees Centigrade.

9. A process according to claim 1 wherein the last effect of the multiple effect evaporation runs at a pressure of between approximately 10 and 30 KPa absolute corresponding to saturated vapour temperatures of between 45.8 and 69.1 degrees Centigrade.

10. A process according to claim 1 wherein the process includes bleeding steam for use outside the evaporator system.

11. A process according to claim 1 wherein the sugar crystals are washed during or following centrifugation.

12. A process according to claim 11 wherein the sugar crystals are washed using a liquor selected from a hot liquor, a secondary liquor and a fine liquor.

13. A process according to claim 5 wherein the process includes seeding the liquor or syrup prior to crystallisation.

14. A process according to claim 1 including the following steps:
a) Concentrating without crystallisation a fine liquor feed stream comprising raw sugar in aqueous solution by falling film evaporation to derive a hot, concentrated syrup,
b) Seeding the syrup with the requisite number of small crystals to create a massecuite
c) Cooling the syrup to grow the sugar crystals within the massecuite,
d) Recovering by centrifugation the sugar crystals from the massecuite to leave a first runoff,
e) Concentrating without crystallisation the first runoff by falling film evaporation to derive a concentrated syrup,
f) Seeding the syrup with the requisite number of small crystals to create a massecuite
g) Cooling the concentrated syrup grow the sugar crystals within the massecuite,
h) Recovering the sugar crystals to leave a second runoff,
i) Repeating steps e) to h) mutatis mutandis at least twice more by way of multiple effect evaporation, and
j) Directing the final runoff to a recovery house.

15. A process according to claim 14 wherein the temperature difference in a cooling crystalliser between the syrup feed and the massecuite derived from the crystalliser is from approximately 95 degrees Centigrade to approximately 25 degrees Centigrade.

16. A process according to claim 15 wherein the temperature of the fine liquor/syrups derived from the falling film evaporation steps is from approximately 85 degrees Centigrade to approximately 100 degrees Centigrade.

17. A process according to claim 14 wherein steps a) and e) are effected in a single operation.

18. A refined crystallised sucrose produced by a process according to claim 1.

19. (canceled)
